(19) United States
(12) Patent Application Publication
(10) Pub. No.: US 2026/0197215 A1
(43) Pub. Date: Jul. 9, 2026

(54) TRANSMITTING DATA TO A NETWORK NODE, AND RECEIVING DATA FROM A NETWORK NODE

(71) Applicant: Telefonaktiebolaget LM Ericsson (publ), Stockholm (SE)

(72) Inventors: Naoki ENDO, Hiratuka-shi, Kanagawa (JP); Naoki ISHIKAWA, Yokohama, Kanagawa (JP); Hiroki IIMORI, Yokohama-shi, Kanagawa (JP); Chandan PRADHAN, Yokohama, Kanagawa (JP); Szabolcs MALOMSOKY, Yokohama, Kanagawa (JP)

(73) Assignee: Telefonaktiebolaget LM Ericsson (publ), Stockholm (SE)

(21) Appl. No.: 19/130,753

(22) PCT Filed: Nov. 17, 2022
(86) PCT No.: PCT/EP2022/082277

§ 371 Date: May 16, 2025

(51) Int. Cl. H04L 27/26; H04L 25/02

(52) U.S. Cl. CPC H04L 27/261; H04L 25/0202

(57) ABSTRACT

Methods and apparatus are provided. In an example, a method of transmitting data to a network node is provided. The method comprises selecting a plurality of reference signal symbols based on data to be transmitted to the network node, and transmitting the reference signal symbols to the network node.

### TECHNICAL FIELD

Example embodiments of this disclosure relate to transmitting data to a network node, and/or receiving data from a network node, such as for example reference signal symbols.

### BACKGROUND

Demand for wireless communication, such as for example according to the 5^{th} Generation (5G) standard and beyond, has continued to grow, resulting in the fact that under the limited radio spectrum, communication technologies that can achieve high spectral efficiency while reducing computational complexity and energy usage will become more important.

In some examples of wireless communication, channel information (a.k.a. Channel State Information, CSI) is required for a receiver to detect data sequences transmitted from UEs. The accuracy of CSI impacts the overall performance of data transmission, e.g., spectrum efficiency [1]. In order to obtain the CSI between a base station and a UE, a reference-signal-based training method has been used. In such scenarios, a UE transmits pilot (i.e., reference) symbols known by both transmitter and receiver, based on which the receiver estimates CSI. Although such training methods result in reliable and high accurate channel estimation, the associated pilot overhead leads to degradation in the overall spectrum efficiency.

To reduce the pilot overhead and improve the spectral efficiency, a number of methods have been proposed, such as the semi-blind method [2, 3], the blind method [4], and the superimposed pilot [5]. In addition, [6] proposed a pilot-imposed approach that transmits pilot and data simultaneously by simply adding a pilot signal onto the data signal and transmitting its combination within the same time and frequency resource block. However, such a superimposed pilot approach is limited in terms of the channel estimation accuracy.

New Radio (NR) uses CP-OFDM (Cyclic Prefix Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols. Data scheduling in NR is typically on a slot basis. An example of NR time-domain structure with 15 kHz subcarrier spacing is shown in FIG. 1 with a 14-symbol slot, where the first two symbols contain physical downlink control channel (PDCCH) and the rest contains a physical shared data channel, either PDSCH (physical downlink shared channel) or PUSCH (physical uplink shared channel) Different subcarrier spacing values are supported in NR. The supported subcarrier spacing values (also referred to as different numerologies) are given by Δf=(15×2μ) kHz, where μ=(0,1,2,3,4). Δf=15 kHz is the basic subcarrier spacing. The slot duration at different subcarrier spacings is given by

$$\frac{1}{{2}^{μ}} ms .$$

In the frequency domain, a system bandwidth is divided into resource blocks (RBs), each corresponds to 12 contiguous subcarriers. The RBs are numbered starting with 0 from one end of the system bandwidth. An example of the NR physical time-frequency resource grid is illustrated in FIG. 2, where only one resource block (RB) within a 14-symbol slot is shown. One OFDM subcarrier during one OFDM symbol interval forms one resource element (RE).

In NR Rel-15, uplink data transmission can be dynamically scheduled using PDCCH. A UE first decodes uplink grants in PDCCH and then transmits data over PUSCH based on the decoded control information in the uplink grant such as modulation order, coding rate, uplink resource allocation, etc.

Demodulation Reference Signal (DM-RS) for PUSCH is an UL reference signal that consists of a pseudo-random QPSK sequence for CP-OFDM or low peak to average power ratio (PAPR) sequences for DFT-S-OFDM. DM-RS is used for demodulating of PUSCH such that the receiver (i.e., the gNB) can handle time-varying and frequency-selective channels. DM-RS is confined to the scheduled PUSCH bandwidth and duration.

The mapping of DM-RS to REs is configurable in both frequency and time domain. In the frequency domain, there are two mapping types: type 1 (comb based) or type 2 (non-comb based). In the time-domain, DM-RS can be either single symbol or double symbol, where the latter means that DM-RS is mapped in pairs of two adjacent symbols. Furthermore, a UE can be configured with one, two, three or four single-symbol DM-RS and one or two double-symbol DM-RS. In low-Doppler scenarios, one DM-RS symbol may be sufficient whereas in high-Doppler scenarios, additional DM-RS symbols may be required.

The frequency-domain starting position of DM-RS is the same as the frequency-domain starting position of PUSCH. The time-domain starting position of DM-RS depends on the PUSCH mapping type:
For PUSCH mapping type A (slot-based scheduling), the first DM-RS symbol is in the third or fourth symbol (i.e., symbol 2 or 3) of a slot, configured by higher-layer parameter DM-RS-TypeA-Position in the Master Information Block (MIB) broadcast by the gNB.
For PUSCH mapping type B (non-slot-based scheduling), the first DM-RS symbol of a slot is the same as the first PUSCH symbol of a slot.

DM-RS for PUSCH is Radio Resource Control (RRC) configured through the DM-RS-UplinkConfig Information Element (IE), for PUSCH scheduled by Downlink Control Information (DCI) format 0_1 or DCI format 0_2. DM-RS for PUSCH is configured in RRC according to 3GPP TS 38.331 version 16.1.0.

DM-RS for PUSCH is configurable with respect to:
The DM-RS frequency-domain mapping type (type 1 or type 2), configured by the RRC parameter DM-RS-Type. Type 1 is comb based with 2 code division multiplexed (CDM) groups, whereas type 2 is not comb based with 3 CDM groups. For DFT-S-OFDM, only type 1 is supported. FIG. 3 illustrates the symbol positions of DM-RS symbols in a resource block for the two DM-RS types 1 and 2. Specifically, FIG. 3(a) illustrates DM-RS symbol positions for DM-RS type 1 single symbol; FIG. 3(b) illustrates DM-RS symbol positions for DM-RS type 1 double symbol; FIG. 3(c) illustrates DM-RS symbol positions for DM-RS type 2 single symbol; and FIG. 3(d) illustrates DM-RS symbol positions for DM-RS type 2 double symbol. In these FIGS. 3(a)-(d), a shaded resource element indicates that a DM-RS symbol is transmitted within that resource element. Note that there are multiple DM-RS ports per CDM group, which are separated using frequency-domain (and time-domain, for double-symbol DM-RS) Orthogonal Cover Codes (OCCs):
   For single-symbol DM-RS, there exist 4 and 6 orthogonal DM-RS ports (2 DM-RS ports per CDM group, separated using a length-2 frequency domain orthogonal cover code, FD-OCC) for type 1 and type 2, respectively.
   For double-symbol DM-RS, there exist 8 and 12 orthogonal DM-RS ports (4 DM-RS ports per CDM group, separated using a length-2 Frequency Domain Orthogonal Cover Code (FD-OCC) combined with a length-2 Time Domain Orthogonal Cover Code (TD-OCC)) for type 1 and type 2, respectively.
Any additional DM-RS symbols (0, 1, 2 or 3 for single-symbol DM-RS and 0 or 1 for double-symbol DM-RS) are configured by the RRC parameter DM-RS-AdditionalPosition. The position of additional DM-RS depends on the PUSCH mapping type and PUSCH duration according to a predefined table. Note that it is not possible to configure a TD-OCC over additional (i.e., noncontiguous DM-RS. FIG. 4 illustrates an example of symbol positions of DM-RS symbols in a resource block for DM-RS type 1 with additional DM-RS symbols. Specifically, FIG. 4(a) shows DM-RS symbol positions for DM-RS type 1, single symbol, with two additional DM-RS symbols, and FIG. 4(b) shows DM-RS symbol positions for DM-RS type 1, double symbol, with one additional DM-RS symbol.
The associated Phase Tracking Reference Signal (PT-RS) (if any) may be configured by the RRC parameter phaseTrackingRS.
The maximum number of adjacent DM-RS symbols (1 or 2) may be configured by the RRC parameter maxLength.

If transform precoding is disabled (i.e., if the waveform is CP-OFDM), DM-RS for PUSCH can be additionally and optionally configured with respect to scrambling ID 0 and 1, configured by RRC parameters scrambling/D0 and scrambling/D1, respectively, which are used for generating the pseudo-random DM-RS sequence.

DM-RS ports are mapped to resource elements within one CDM group. DM-RS ports that belong to the same CDM group are separated by a length-2 FD-OCC (and a length-2 TD-OCC, for double-symbol DM-RS). In NR Rel-16, the DM-RS sequence is mapped to the following subcarriers (for DFT-S-OFDM, only DM-RS type 1 is supported):

$$k = \{ \begin{matrix}4 n + 2 {k}^{′} + Δ , & for type 1 , \\ 6 n + {k}^{′} + Δ , & for type 2 .\end{matrix}$$

Here, k is the subcarrier index (which starts/ends at the first/last subcarrier within the scheduled PUSCH bandwidth), n∈{0,1,2, . . . }, k′∈{0,1}, and Δ is an offset that depends on the CDM group.

In Table 1 and Table 2, we show port-specific parameters for DM-RS type 1 and type 2. Here, w_{f}(k′), where k′∈{0,1}, is the FD-OCC and wₜ(l′), where l′=0 for single-symbol DM-RS and l′∈{0,1} for double-symbol DM-RS, is the TD-OCC. Note that DM-RS ports in different CDM groups are separated by different offsets and that DM-RS ports within the same CDM group are separated through coding.

TABLE 1
Parameters for PUSCH DM-RS configuration type 1
(reproduced from Table 6.4.1.1.3-1 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 2
Parameters for PUSCH DM-RS configuration type 2
(reproduced from Table 6.4.1.1.3-2 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

From the transmitter's perspective, the number of DM-RS ports used for PUSCH transmission coincides with the transmission rank, i.e., one DM-RS port per transmitted layer. The DM-RS port mapping is signaled to the UE from the gNB via DCI. Tables 3 and 4 below show such an indication for DCI 0_1, CP-OFDM, single-symbol DM-RS type 1, and for transmission rank 1 and 2, respectively. Similar tables can be found in 3GPP TS 38.212 version 16.10.0 for rank 3 and 4, double-symbol DM-RS, and for DM-RS type 2. Subcarriers, which are associated with a CDM group, that are not used for DM-RS can be used for PUSCH. After layer mapping, the DM-RS and the associated PUSCH are mapped to physical antennas through precoding.

TABLE 3
Antenna ports for single-symbol DM-RS type 1, transform
precoding is disabled, rank-1 transmission (reproduced
from Table 7.3.1.1.2-8 of 3GPP 38.212 version 16.10.0).

| | Number of DM-RS CDM | DM-RS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 4
Antenna ports for single-symbol DM-RS type 1, transform
precoding is disabled, rank-2 transmission (reproduced
from Table 7.3.1.1.2-9 of 3GPP 38.212 version 16.10.0).

| | Number of DM-RS CDM | DM-RS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

The training methods referred to above have been adopted in typical wireless communications standards. Its spectrum efficiency inevitably becomes worse for high-mobility scenarios due to the fact that more reference symbols are needed to track and estimate the varying channel accurately, which increases the communication overhead. This calls for need to find methods to eliminate or reduce overhead due to use of reference symbols, to achieve higher spectral efficiency for 5G-advanced and beyond.

An approach to tackle the pilot overhead is the use of differential space-time coding, which does not require periodic pilot symbols and supports the scenarios where CSI fluctuates rapidly overtime. It enables noncoherent detection by encoding the information onto the signal difference between time slots. Its major issue is that one needs to concede a 3 dB SNR loss at best and a low spectrum efficiency due to the nature of the differential coding.

Semi-blind methods [2,3] have been proposed also to reduce pilot overheads. Semi-blind approaches first estimate the CSI roughly by using a short reference signal sequence and intend to improve the CSI by taking advantage of the data and performing joint channel and data detection. Although this approach improves the spectrum efficiency compared to coherent counterparts, transmitting a reference signal still limits the improvement on the spectrum efficiency.

In line with the blind method, another approach [4] estimates CSI by using second order statistics of received signals and algebraic properties of the symbol. The major problem of this method is that it is difficult to determine the phase of the channel response in the complex domain, resulting in inferior channel estimation performance. To resolve this issue, it is needed to transmit a pilot tuple or use an asymmetric constellation. The method in [4] uses Orthogonal Space-Time Block Coding (OSTBC) symbols and estimates CSI from a covariance matrix of the received signal, which requires a long coherence time to obtain CSI, leading to a significant amount of latency.

Finally, the approaches [5,6] superimpose pilot symbols onto data symbols on the complex domain. This enables simultaneous estimation of channel and data at the receiver. In massive MIMO scenarios, the superimposed pilot is effective in mitigating pilot contamination in both uplink [7] and downlink [8]. However, this method deteriorates the spectrum efficiency as the transmit power that is allocated to data symbols decreases.

Overall, the above approaches are shown to be limited [10] in terms of either channel estimation performance or spectrum efficiency, while being incompatible with the 3GPP standard signaling structure.

### SUMMARY

Examples of this disclosure may have certain advantages. For example, embodiments of this disclosure may enable improvements on the spectrum efficiency by replacing reference signals (e.g., DM-RS in NR) with a codeword, such as for example from a Grassmann manifold, where each codeword can convey data bits. The estimated CSI can then for example be utilized to detect data symbols as is the case with the conventional approaches. Thus, the disclosed methodology may for example improve the overall spectrum efficiency by adding data bits encoded on the specific pilot structure, which in some examples is based on the Grassmann manifold.

One aspect of the present disclosure provides a method of transmitting data to a network node. The method comprises selecting a plurality of reference signal symbols based on data to be transmitted to the network node, and transmitting the reference signal symbols to the network node.

Another aspect of the present disclosure provides a method of receiving data from a network node. The method comprises receiving a plurality of reference signal symbols from the network node, and determining, based on the reference signal symbols, the data transmitted by the network node.

An additional aspect of the present disclosure provides apparatus for transmitting data to a network node. The apparatus comprises a processor and a memory. The memory contains instructions executable by the processor such that the apparatus is operable to select a plurality of reference signal symbols based on data to be transmitted to the network node, and transmit the reference signal symbols to the network node.

A further aspect of the present disclosure provides apparatus for receiving data from a network node. The apparatus comprising a processor and a memory. The memory contains instructions executable by the processor such that the apparatus is operable to receive a plurality of reference signal symbols from the network node, and determine, based on the reference signal symbols, the data transmitted by the network node.

A still further aspect of the present disclosure provides apparatus for transmitting data to a network node. The apparatus is configured to select a plurality of reference signal symbols based on data to be transmitted to the network node, and transmit the reference signal symbols to the network node.

Another aspect of the present disclosure provides apparatus for receiving data from a network node. The apparatus is configured to receive a plurality of reference signal symbols from the network node, and determine, based on the reference signal symbols, the data transmitted by the network node.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of a NR time-domain structure with 15 kHz subcarrier spacing;

FIG. 2 illustrates an example of a NR physical time-frequency resource grid;

FIG. 3 illustrates the symbol positions of DM-RS symbols in a resource block for DM-RS types 1 and 2;

FIG. 4 illustrates an example of symbol positions of DM-RS symbols in a resource block for DM-RS type 1 with additional DM-RS symbols;

FIG. 5 is a flow chart of an example of a method of transmitting data to a network node;

FIG. 6 is a flow chart of an example of a method of receiving data from a network node;

FIG. 7 shows examples of a single symbol and a double symbol Type 1 Grassmann DM-RS;

FIG. 8, which shows an example of repetition of a Grassmann based DM-RS sequence in the frequency domain;

FIG. 9 shows examples of a Grassmann based DM-RS sequence divided into groups for a DM-RS port while utilizing consecutive OFDM symbols;

FIG. 10 shows examples of use of both legacy DM-RS and DM-RS according to this disclosure;

FIG. 11 is a schematic of an example of an apparatus for transmitting data to a network node; and

FIG. 12 is a schematic of an example of an apparatus for receiving data from a network node.

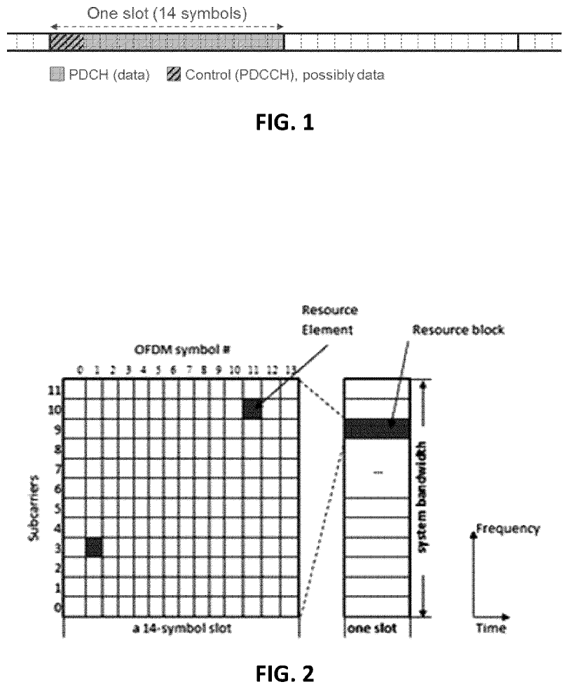

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

As indicated above, example embodiments of this disclosure may enable improvements on the spectrum efficiency by replacing reference signals (e.g., DM-RS in NR) with a codeword, such as for example from a Grassmann manifold, where each codeword can convey data bits.

FIG. 5 is a flow chart of an example of a method 500 of transmitting data to a network node. In some examples, the network node is a Radio Access Network (RAN) node, such as a base station, gNodeB, eNodeB, or similar. In such examples, the method 500 may be performed by a User Equipment (UE). Alternatively, in some examples, the network node is a UE, and the method 500 may be performed by a RAN node, such as a base station, gNodeB, eNodeB, or similar.

The method 500 comprises, in step 502, selecting a plurality of reference signal symbols based on data to be transmitted to the network node. The plurality of reference signal symbols may in some examples be (or used by the network node as) a demodulation reference signal (DM-RS). Step 504 of the method comprises transmitting the reference signal symbols to the network node.

In some examples, selecting the plurality of reference signal symbols in step 502 comprises selecting one of a plurality of different reference signal symbol sequences, wherein each reference signal symbol sequence is associated with a different value for the data.

Therefore, for example, transmission of the selected symbol sequence of reference signal symbols conveys data through the particular sequence that is selected. In particular examples, there are n reference signal symbols, and the number of reference signal symbol sequences from which the transmitted reference signal symbols are selected is 2^{B} with B being the number of bits encoded within the reference signal symbol sequences.

In some examples, selecting the plurality of reference signal symbols in step 502 comprises selecting one of a plurality of constellation points in a symbol constellation, wherein each constellation point represents a different reference signal symbol sequence. There may be fewer than 2n constellation points in some examples, where n is the number of reference signal symbols. The reference signal symbol sequences may in some examples be referred to as a set of codewords forming a codebook.

In some examples, the number of reference signal symbol sequences is the number of constellation points, such as for example constellation points on a Grassmanian manifold (explained further below). The Grassmann manifold may be at least a 2n dimension manifold, where n is the number of reference signal symbols. Thus for example each reference signal symbol transmitted in step 504 may convey two dimensions of the constellation point on the Grassmann manifold.

The reference signal symbols may in some examples be repeated. The method 500 may therefore comprise transmitting the reference signal symbols in a plurality of first resource elements, and repeating the reference signal symbols in a plurality of second resource elements. The first plurality of resource elements are within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the plurality of reference signal symbols correspond to a first antenna port. In such examples, the method 500 may comprise, for each of one or more further antenna ports, transmitting further reference signal symbols to the network node (for example, in the same resource block, slot, mini-slot, subframe and/or frame as the plurality of reference signal symbols selected in step 502). The method 500 may also comprise, for each of the one or more further antenna ports, selecting the further reference signal symbols based on respective further data to be transmitted to the network node. This may be selected in a manner similar to the plurality of reference signal symbols referred to above, e.g. from a plurality of symbol sequences, from a plurality of constellation points, or from a plurality of constellation points on a Grassmann manifold. Alternatively, the further reference symbols may comprise legacy reference signal symbols for example.

The method 500 may also in some examples comprise transmitting additional reference signal symbols to the network node, wherein the additional reference signal symbols correspond to a legacy reference signal (for example, in the same resource block, slot, mini-slot, subframe and/or frame as the plurality of reference signal symbols selected in step 502). Thus, for example, a resource block, slot, mini-slot, subframe and/or frame may include both legacy reference signal symbols and reference signal symbols that convey data as selected in step 502 of the method 500.

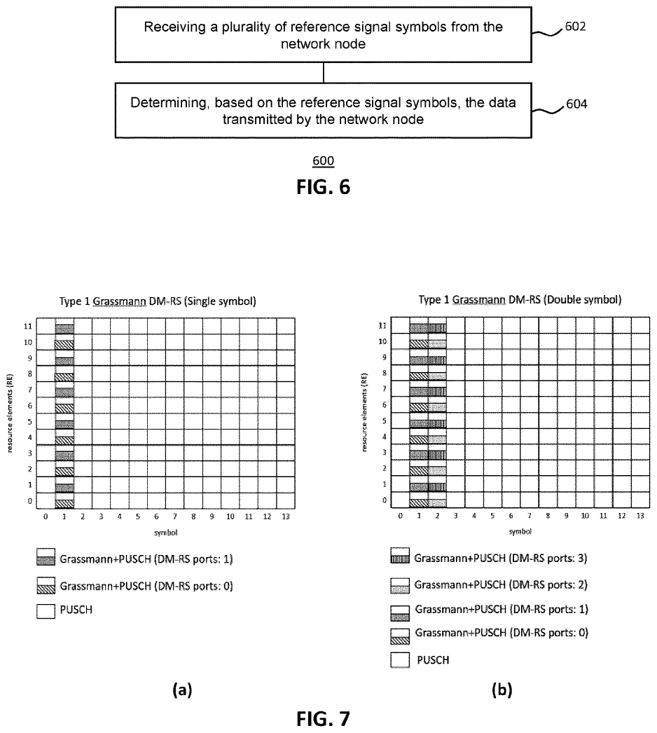

FIG. 6 is a flow chart of an example of a method 600 of receiving data from a network node. In some examples, the network node is a Radio Access Network (RAN) node, such as a base station, gNodeB, eNodeB, or similar. In such examples, the method 600 may be performed by a User Equipment (UE). Alternatively, in some examples, the network node is a UE, and the method 600 may be performed by a RAN node, such as a base station, gNodeB, eNodeB, or similar. In some examples, the network node from which the data is received performs the method 500 referred to above.

The method 600 comprises, in step 602, receiving a plurality of reference signal symbols from the network node. Step 604 of the method 600 comprises determining, based on the reference signal symbols, the data transmitted by the network node.

In some examples, determining the data transmitted by the network node comprises determining the data represented by the reference signal symbols. For example, each of the different reference signal symbol sequences may represent respective data, and determining the data transmitted by the network node may comprise determining the data represented by the reference signal symbol sequence that matches the received reference signal symbols.

In some examples, determining the data transmitted by the network node comprises determining that the plurality of reference signal symbols comprise one of a plurality of different reference signal symbol sequences (e.g. codewords in a codebook), wherein each reference signal symbol sequence is associated with a different value for the data. There may be for example n reference signal symbols, and the number of reference signal symbol sequences may depend on the throughput requirement. Thus, for example, the data may be determined by matching the received reference signal symbols to one of the reference signal symbol sequences, and the transmitted data corresponds to the value for the data associated with the matched reference signal symbol sequence.

Determining the data transmitted by the network node may in some examples comprise determining that the plurality of reference signal symbols comprise one of a plurality of constellation points in a symbol constellation, wherein each constellation point represents a different reference signal symbol sequence. If n is the number of reference signal symbols, then the number of constellation points in the symbol constellation may be less than 2n. In some examples, the constellation points are points on a Grassmannian manifold, explained further below. The Grassmann manifold may be for example at least a 2n dimension manifold, where n is the number of reference signal symbols.

The reference signal symbols may in some examples be repeated. The method 600 may therefore comprise receiving the reference signal symbols in a plurality of first resource elements, and receiving a repeat of the reference signal symbols in a plurality of second resource elements. The first plurality of resource elements are within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the plurality of reference signal symbols correspond to a first antenna port. In such examples, the method 600 may comprise, for each of one or more further antenna ports, receiving further reference signal symbols to the network node (for example, in the same resource block, slot, mini-slot, subframe and/or frame as the plurality of reference signal symbols selected in step 502). The method 500 may also comprise, for each of the one or more further antenna ports, determining, based on the further reference signal symbols, respective further data transmitted by the network node. This may be determined in a manner similar to the plurality of reference signal symbols referred to above, e.g. from a plurality of symbol sequences, from a plurality of constellation points, or from a plurality of constellation points on a Grassmann manifold. Alternatively, the further reference symbols may comprise legacy reference signal symbols for example.

The method 600 may also in some examples comprise receiving additional reference signal symbols from the network node, wherein the additional reference signal symbols correspond to a legacy reference signal (for example, in the same resource block, slot, mini-slot, subframe and/or frame as the plurality of reference signal symbols selected in step 502). Thus, for example, a resource block, slot, mini-slot, subframe and/or frame may include both legacy reference signal symbols, which do not convey data, and reference signal symbols that convey the data that is determined in step 604 of the method 600.

As indicated above, in examples of this disclosure a Grassmann constellation may be used to select symbols for a data-carrying DM-RS, for example in place of legacy DM-RS. A Grassmann manifold may be used to construct DM-RS symbols which can carry data on top of it compared to legacy DM-RS symbols. In some examples, the Grassmann-based DM-RS may be configured in a User Equipment by a network node (e.g. base station, eNodeB, gNodeB) through Radio Resource Control (RRC) signaling.

Particular examples based on use of a Grassmann manifold are now described, though the concepts described may also be applied to other examples that use other constellations and/or symbol sequences.

Some Grassmann-based non-coherent transmission methodologies have been reported, e.g., [11], in which several multidimensional Grassmann constellations have been suggested. Despite such Grassmann constellation designs, utilizing a Grassmann constellation in place of a reference signal in 5G NR configuration has not been suggested in the prior art.

### Grassmann Manifold Based Transmission

Consider a UE with M antennas transmitting to a gNB with N antennas. Concatenating received signals over temporal length T, with T>M, the received signal model can be given by:

$$Y = XH + V , \qquad ( 1 )$$

where Y∈ [symbol] ^{T×N} is the received signal matrix, X∈ [symbol] ^{T×M} is the transmitted matrix constructed from a T-dimensional Grassmann manifold [9,10], H∈ [symbol] ^{M×N} is the effective channel matrix consisting of the precoding matrix, receiver filter, and fading channel matrix, and V∈ [symbol] ^{T×N} is the noise matrix. Next, a possible approach to estimate the transmitted matrix X and the channel matrix H is described.

### Estimation of the Transmitted Matrix X

In order to estimate the channel matrix, the transmitted matrix X is firstly estimated, where X is one of the discrete points represented by the pre-defined MT-dimensional Grassmann manifold. Although any reasonable detection methodology can be considered to detect the transmitted matrix X, a generalized likelihood ratio test (GLRT) is presented here, which is to solve the following maximization problem:

$$\hat{X} = {arg max}_{\dot{X} ∈ χ} Tr \{ {YY}^{H} \dot{X} {\dot{X}}^{H} \} , \qquad ( 2 )$$

where \hat{X} is the estimate of the transmitted matrix X and [symbol] is a set of discrete points on MT-dimensional space defined by the pre-determined Grassmann manifold. Due to the discreteness of [symbol] , digital data symbols can be encoded on each discrete point on MT-dimensional space. The difference from the digital modulation is that the discrete point of X is defined in a multidimensional space in contrast to the complex space (i.e., [symbol] ) of digital modulation schemes.

### Estimation of the Transmitted Matrix H

Given the estimate \hat{X}, the channel matrix H can also be estimated by any channel estimation method that assumes the knowledge of matrix X. For example, with the zero-forcing method the estimate of H is given by:

$$\hat{H} = {( {\hat{X}}^{H} \hat{X} )}^{- 1} {\hat{X}}^{H} Y . \qquad ( 3 )$$

Alternatively, assuming availability of the covariance matrix of the receiver noise Cov(V), the estimate of H with the minimum mean square error (MMSE) estimator is given by:

$$\hat{H} = {( {\hat{X}}^{H} \hat{X} + Cov ( V ) )}^{- 1} {\hat{X}}^{H} Y . \qquad ( 4 )$$

In a similar embodiment, a joint detection of the matrix H and matrix X can be considered.

In some examples, a method to apply Grassmann manifold-based DM-RS for demodulation of transmitted symbols in a NR system is provided. Though in the following example the method is described for an uplink NR transmission from a User Equipment (UE) to a gNodeB (gNB), the method (and other methods of this disclosure) can be applied to any general wireless communication system, including uplink, downlink, sidelink, peer-to-peer, and others, and between any two network nodes. Also, in this example, PUSCH data symbols are sent using a DM-RS, though in other examples any data may be sent.

Unlike the legacy DM-RS, PUSCH data symbols are superimposed on to the Grassmann based DM-RS, resulting in higher spectral efficiency. Accordingly, consider a User Equipment (UE) with u DM-RS antennas ports serving the gNB. Considering a DM-RS sequence for a port is spread over Nₛ subcarriers, the received signal for the DM-RS ports transmitting over same OFDM symbol but different subcarriers, given by υ̅≤υ, can be given by:

$${Y}_{u} = {X}_{u} {H}_{u} + {V}_{u} , \qquad ( 5 )$$

where Yᵤ∈ [symbol] ^{υ̅N}^{ₛ}^{×υ̅} is the received signal matrix, Xᵤ∈ [symbol] ^{υ̅N}^{ₛ}^{×υ̅} is block-diagonal matrix such that, Xᵤ=blkdiag(x₁, . . . , x_{υ̅}), where xᵢ∈ [symbol] ^{N}^{ₛ}^{×1} is a Nₛ-dimensional Grassmann manifold [9,10] transmitted through i^{th} DM-RS port, Hᵤ∈ [symbol] ^{υ̅×υ̅} is the effective channel matrix incorporating the precoding matrix, receiver filter, and the propagation channel matrix, and Vᵤ∈ [symbol] ^{υ̅N}^{ₛ}^{×υ̅} is the noise matrix. At the gNB, the transmitted matrix and the channel matrix can be estimated with methodologies similar to that described above. Note that though the Grassmann manifold is used to describe the joint pilot and data transmission in this example, the general principle applies to any multi-dimensional constellation capable of carrying data symbols (PUSCH/PDSCH) on top of it

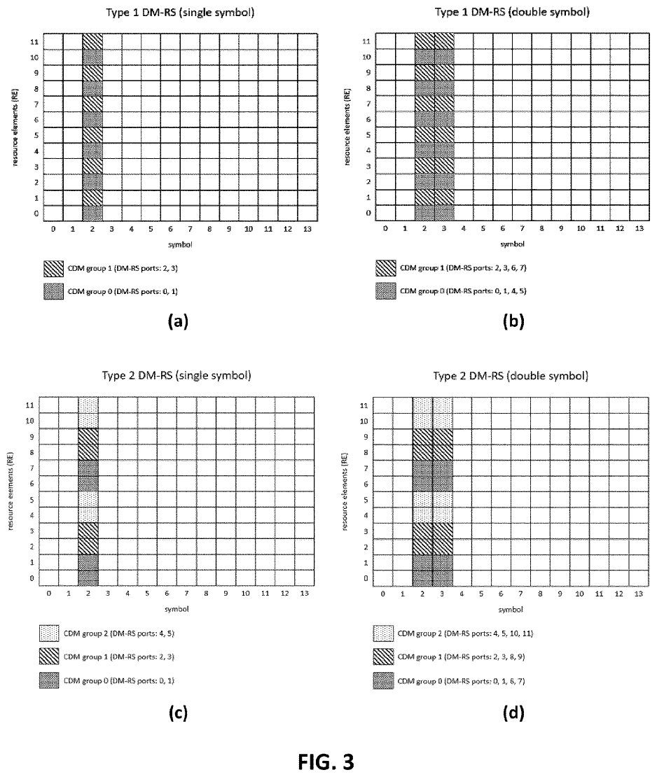

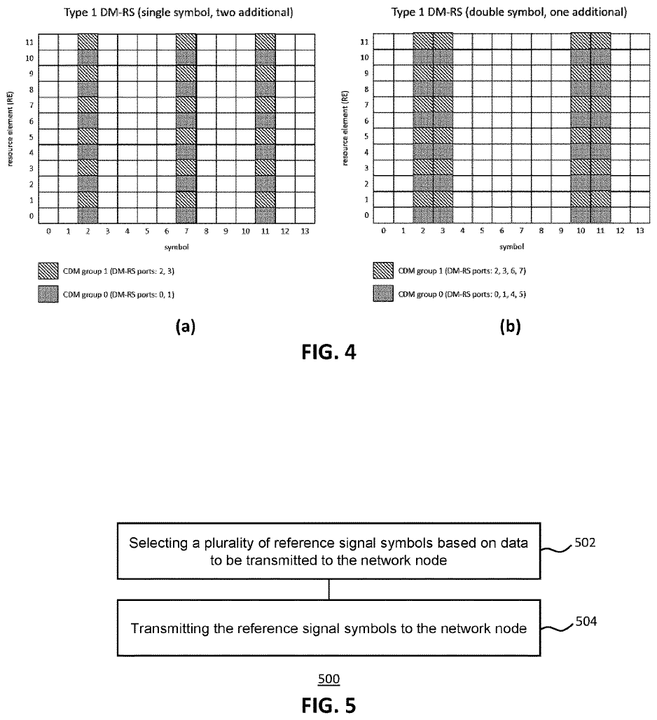

In an example, the Grassmann sequence of each port with length Nₛ can be mapped to resource elements (REs) in a manner similar to legacy Type 1 DM-RS mapping described above, giving two DM-RS ports. Furthermore, in the time-domain, DM-RS can be single symbol or double symbol as shown in FIG. 3(a)-(d). Accordingly, two and four Grassmann based DM-RS ports are possible with one and two-time domain DM-RS symbol, respectively, considering υ̅=2, as shown in FIG. 7. Specifically, FIG. 7(a) shows an example of a single symbol Type 1 Grassmann DM-RS, and FIG. 7(b) shows an example of a double symbol Type 1 Grassmann DM-RS. In a related example, the Grassmann based DM-RS can be mapped to REs in a Type 2 manner as shown in FIGS. 3(c) and (d) for legacy DM-RS. Note that the Grassmann based DM-RS can be configured with arrangements other that Type 1 and 2, since they can carry PUSCH on top of them.

Though in the above examples, the DM-RS ports per frequency and time resource, i.e., the same subcarriers and time resources (e.g. the same resource element(s)), is limited to one, in some examples code division multiplexing (CDM) using orthogonal cover codes (OCCs) can be mapped on to the Grassmann based DM-RS to transmit more than one DM-RS port using same frequency and time resources in some examples. In another example, where the DM-RS is double symbol such as Type 2 referred to above, one OFDM symbol of the double symbol may be a legacy DM-RS while the other OFDM symbol can be a data-carrying DM-RS according to the present disclosure, such as for example a Grassmann based DM-RS.

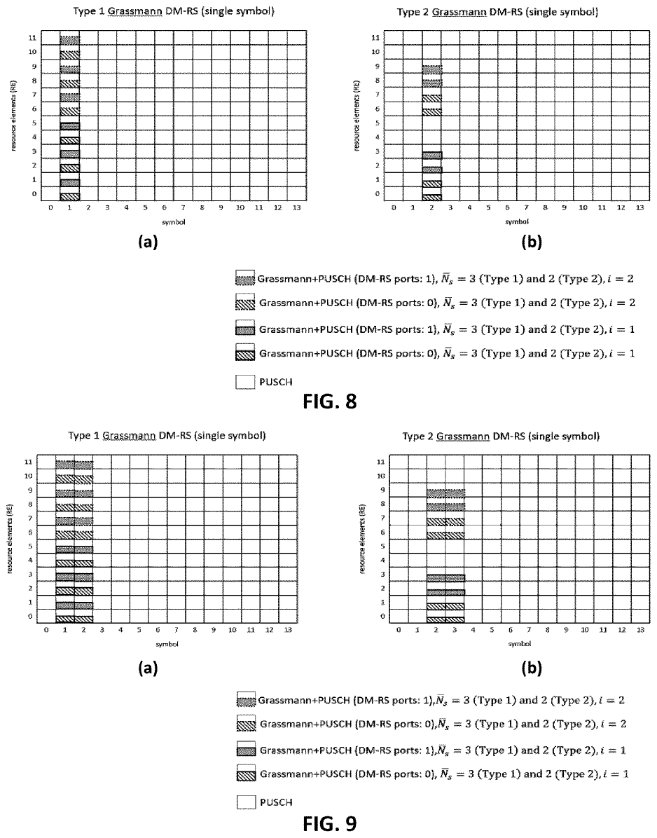

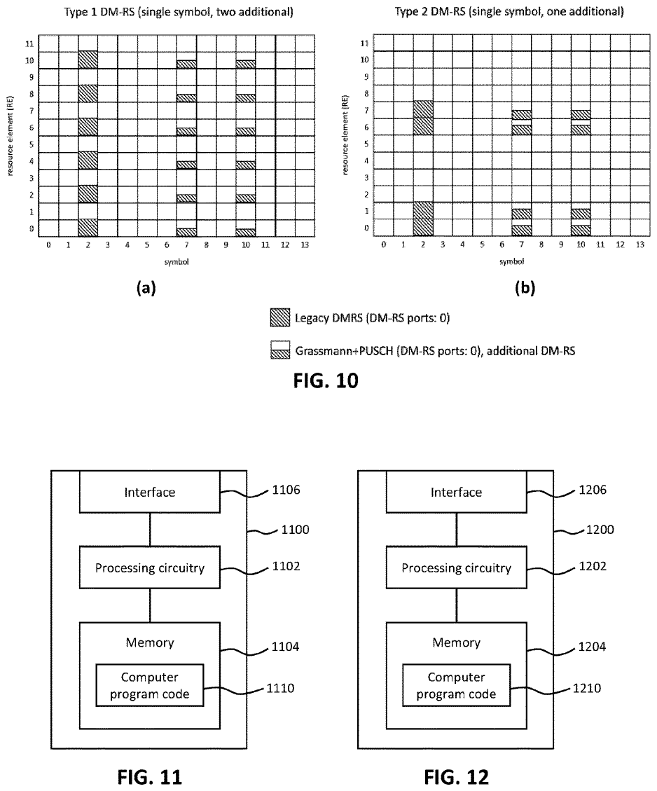

In some examples of this disclosure, the accuracy of channel estimation depends on the frequency selectivity of the channel. For a frequency-flat channel, the channel across the allocated bandwidth is equivalent giving an accurate channel estimation. However, with an increase in the frequency selectivity, the accuracy of the channel estimation may degrade in some examples for a Grassmann based DM-RS. Furthermore, the decoding complexity may be proportional to the Grassmann based DM-RS sequence length Nₛ. Hence, in some examples, Nₛ can be divided into smaller equal lengths N̅ₛ, such that N̅ₛI=Nₛ, I∈ [symbol] . Accordingly, a shorter Nₛ Grassmann based DM-RS sequence is repeated 1 times to cover Nₛ subcarriers, as suggested above with reference to the method 500 or 600. This may for example allow estimation over a smaller bandwidth with lower frequency selectivity while having a lower complexity for each of the smaller sequences. As an example, the above embodiment is illustrated in FIG. 8, which shows an example of repetition of a Grassmann based DM-RS sequence in the frequency domain. Specifically, FIG. 8(a) shows an example of the Grassmann based DM-RS sequence divided into groups for a DM-RS port, with each group occupying N̅ₛ=3 subcarriers for Type 1 arrangement, and FIG. 8(b) shows N̅ₛ=2 subcarriers for Type 2 arrangement.

In a related example, if more accurate channel estimation is needed, a Grassmann based DM-RS sequence can be sent over N̅ₛ subcarriers and two or more consecutive OFDM symbols, resulting in modification of Yᵤ∈ [symbol] ^{υ̅N}^{ₛ}^{N}^{ₜ}^{×υ̅} and:

$${X}_{u} = ( \begin{matrix}blkdiag ( {x}_{1}^{1} , ⋯ , x \frac{1}{u} ) \\ blkdiag ( {x}_{1}^{2} , ⋯ , x \frac{2}{u} ) \\ ⋮ \\ blkdiag ( {x}_{1}^{T} , ⋯ , x \frac{T}{u} )\end{matrix} ) , \qquad ( 6 )$$

where T is the number of consecutive OFDM symbols and

$$x \frac{t}{u} ∈ {ℂ}^{{N}_{s} \times 1}$$

is a Nₛ-dimensional Grassmann manifold [9,10] transmitted through i^{th} DM-RS port at t^{th} OFDM symbol. This can allow more accurate channel estimation of a high frequency selective channel by taking advantage of time domain. An example of this is illustrated in FIG. 8, where the Grassmann based DM-RS sequence is divided into groups for a DM-RS port while utilizing T=2 consecutive OFDM symbols.

Specifically, FIG. 8(a) shows an example of a single symbol Type 1 Grassmann DM-RS, and FIG. 8(b) shows an example of a single symbol Type 2 Grassmann DM-RS. This example relates to front-loaded PUSCH (i.e., PUSCH mapping type A) of duration 14 symbols. The Grassmann based DM-RS sequence is divided into groups for a DM-RS port, where each group occupies N̅ₛ=3 subcarriers and N̅ₛ=2 subcarriers for Type 1 and Type 2 kind of arrangement, respectively. The figures show two such groups, i.e., i=1, 2, for a resource block.

The frequency and time domain starting positions of DM-RS according to this disclosure, such as for example a Grassmann based DM-RS or any other example of a data-carrying DM-RS, can follow the configuration similar to legacy DM-RS as described above. In low-Doppler scenarios, similar to legacy DM-RS, one Grassmann based DM-RS symbol may be sufficient, whereas, in high-Doppler scenarios, additional Grassmann based DM-RS symbols may be useful or needed in some examples.

While legacy DM-RS can have the advantage of higher channel estimation accuracy and low decoding complexity in some examples, the DM-RS according to this disclosure (e.g. Grassmann based DM-RS) may impart additional spectral efficiency by superimposing PUSCH onto the Grassmann based DM-RS sequence. Accordingly, in some examples, both legacy DM-RS and DM-RS according to this disclosure can be used (e.g. in a resource block, slot, mini-slot, subframe and/or frame) to achieve advantages of both the legacy DM-RS and the DM-RS according to this disclosure. For example, in a high doppler scenario, a first DM-RS symbol in a resource block can be a legacy DM-RS, and a subsequent DM-RS can be a DM-RS according to this disclosure, such as for example Grassmann based DM-RS. An example is shown in FIG. 9. Specifically, FIG. 9(a) shows an example where one additional DM-RS position is configured for Type 1, and FIG. 9(b) shows an example where one additional DM-RS position is configured for Type 2, for a single symbol DM-RS. This example relates to front-loaded PUSCH (i.e., PUSCH mapping type A) of duration 14 symbols. The first DM-RS symbols use the legacy sequence, where the two additional DM-RS symbols in the slot use Grassmann based DM-RS.

In some examples, the use of either or both legacy DM-RS and/or DM-RS according to this disclosure can be signaled to a network node, such as a UE, by another network node, such as a gNB. This may be done for example through higher layer RRC signaling by including additional information elements in the DM-RS-config parameter structure (discussed in Section 2.1.2.1). Examples of additional parameters may include one or more of:
‘DM-RS-Sequence’ can signal the use of legacy DM-RS, DM-RS according to this disclosure, or both,
‘DM-RS-AdditionalSequence’ signals a bit sequence equal to number of DM-RS symbols in a slot to indicate either the use of legacy DMRS or DM-RS according to this disclosure in each DM-RS symbol position, where position of legacy DM-RS and/or DM-RS according to this disclosure can be signaled by the gNB through RRC connection using DM-RS-AdditionalPosition information element in DM-RS-config parameter structure.

In a related example, where Phase Tracking Reference Signal (PT-RS) is configured in a slot, the PT-RS can be signaled to occupy the subcarriers and OFDM symbols such that they do not overlap with the DM-RS (e.g. DM-RS according to this disclosure such as a Grassmann based DM-RS) if used in the slot. Alternatively, the DM-RS can be configured not to overlap with the PT-RS REs.

FIG. 11 is a schematic of an example of an apparatus 1100 for transmitting data to a network node. The apparatus 1100 comprises processing circuitry 1102 (e.g. one or more processors) and a memory 1104 in communication with the processing circuitry 1102. The memory 1104 contains instructions, such as computer program code 1110, executable by the processing circuitry 1102. The apparatus 1100 also comprises an interface 1106 in communication with the processing circuitry 1102. Although the interface 1106, processing circuitry 1102 and memory 1104 are shown connected in series, these may alternatively be interconnected in any other way, for example via a bus.

In one embodiment, the memory 1104 contains instructions executable by the processing circuitry 1102 such that the apparatus 1100 is operable/configured to select a plurality of reference signal symbols based on data to be transmitted to the network node, and transmit the reference signal symbols to the network node. In some examples, the apparatus 1100 is operable/configured to carry out the method 500 described above with reference to FIG. 5.

FIG. 12 is a schematic of an example of an apparatus 1200 for receiving data from a network node. The apparatus 1200 comprises processing circuitry 1202 (e.g. one or more processors) and a memory 1204 in communication with the processing circuitry 1202. The memory 1204 contains instructions, such as computer program code 1210, executable by the processing circuitry 1202. The apparatus 1200 also comprises an interface 1206 in communication with the processing circuitry 1202. Although the interface 1206, processing circuitry 1202 and memory 1204 are shown connected in series, these may alternatively be interconnected in any other way, for example via a bus.

In one embodiment, the memory 1204 contains instructions executable by the processing circuitry 1202 such that the apparatus 1200 is operable/configured to receive a plurality of reference signal symbols from the network node, and determine, based on the reference signal symbols, the data transmitted by the network node. In some examples, the apparatus 1200 is operable/configured to carry out the method 600 described above with reference to FIG. 6.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. 3GPP TS38.101-1 V17.3.0, “NR; User Equipment (UE) radio transmission and reception,” Part1: Range 1 Standalone (Release 17), September 2021.
2. A. Medles and D. T. M. Slock, “Semiblind channel estimation for MIMO spatial multiplexing systems,” in IEEE Vehicular Technology Conference, 2001.
3. S. Chen, S. Sugiura, and L. Hanzo, “Semi-blind joint channel estimation and data detection for space-time shift keying systems,” IEEE Signal Processing Letters, 2010.
4. S. Shahbazpanahi, A. B. Gershman, and J. H. Manton, “Closed-form blind MIMO channel estimation for orthogonal space-time block codes,” IEEE Transactions on Signal Processing, 2005.
5. P. Hoeher and F. Tufvesson, “Channel estimation with superimposed pilot sequence,” in IEEE GLOBECOM, Rio de Janeiro, Brazil, 5-9 Dec. 1999.
6. Andrea Ancora and Matthew Baker, “Radio communication system”, United States Patent US20100159914A1,24 Jun. 2010.
7. K. Upadhya, S. A. Vorobyov, and M. Vehkaperä, “Downlink performance of superimposed pilots in massive MIMO systems,” IEEE Transactions on Wireless Communications, 2018.
8. D. Verenzuela, E. Björnson, and L. Sanguinetti, “Spectral and energy efficiency of superimposed pilots in uplink massive MIMO,” IEEE Transactions on Wireless Communications, vol. 17, no. 11, pp. 7099-7115, November 2018.
9. I. Kammoun and J. C. Belfiore, “A new family of Grassmann space-time codes for non-coherent MIMO systems,” IEEE Communications Letters, vol. 7, no. 11, pp. 528-530, November 2003
10. K. H. Ngo, A. Decurninge, M. Guillaud, and S. Yang, “Cubesplit: A structured Grassmannian constellation for non-coherent SIMO communications,” arXiv:1905.08745 [cs, math], June 2020.
11. K. H. Ngo, A. Decurninge, M. Guillaud, and S. Yang, “Transmitter and receiver communication apparatus for non-coherent communication”, U.S. Pat. No. 11,258,649B2, February 2022

1-51. (canceled)

52. A method of transmitting data to a network node, the method comprising:
selecting a plurality of reference signal symbols based on data to be transmitted to the network node, wherein the plurality of reference signal symbols correspond to a first antenna port;
transmitting the reference signal symbols to the network node; and
for each of one or more further antenna ports, transmitting further reference signal symbols to the network node.

53. The method of claim 52, wherein selecting the plurality of reference signal symbols comprises selecting one of a plurality of different reference signal symbol sequences, wherein each reference signal symbol sequence is associated with a different value for the data.

54. The method of claim 53, wherein
there are n reference signal symbols, and
the number of reference signal symbol sequences is 2\hat{ }B with B being the number of bits encoded within the reference signal symbol sequences.

55. The method of claim 52, wherein
selecting the plurality of reference signal symbols comprises selecting one of a plurality of constellation points in a symbol constellation, and
each constellation point represents a different reference signal symbol sequence.

56. The method of claim 55, wherein
n is the number of reference signal symbols, and
selecting one of a plurality of constellation points comprises selecting a constellation point from a number of constellation points of 2\hat{ }B with B being the number of bits encoded within the constellation points.

57. The method of claim 55, wherein
the constellation points are points on a Grassmannian manifold, and
the Grassmann manifold is at least a 2n dimension manifold, where n is the number of reference signal symbols.

58. The method of claim 52, further comprising transmitting the reference signal symbols in a plurality of first resource elements.

59. The method of claim 52, wherein the reference signal symbols are symbols of a pilot signal or a demodulation reference signal (DM-RS).

60. The method of claim 52, wherein the method is performed by a Radio Access Node (RAN).

61. A method of receiving data from a network node, the method comprising:
receiving a plurality of reference signal symbols from the network node, wherein the plurality of reference signal symbols correspond to a first antenna port, for each of one or more further antenna ports, receiving further reference signal symbols from the network node; and
determining, based on the reference signal symbols, the data transmitted by the network node.

62. The method of claim 61, wherein
determining the data transmitted by the network node comprises determining that the plurality of reference signal symbols comprise one of a plurality of constellation points in a symbol constellation, and
each constellation point represents a different reference signal symbol sequence.

63. The method of claim 62, wherein
the constellation points are points on a Grassmannian manifold, and
the Grassmann manifold is at least a 2n dimension manifold, where n is the number of reference signal symbols.

64. The method of claim 61, further comprising performing channel estimation using the reference signal symbols.

65. The method of claim 61, wherein the reference signal symbols are symbols of a pilot signal or a demodulation reference signal (DM-RS).

66. The method of claim 61, wherein the network node comprises a User Equipment (UE).

67. The method of claim 61, wherein determining, based on the reference signal symbols, the data transmitted by the network node comprises determining the data represented by the reference signal.

68. An apparatus for transmitting data to a network node, the apparatus comprising a processor and a memory, the memory containing instructions executable by the processor such that the apparatus is operable to:
select a plurality of reference signal symbols based on data to be transmitted to the network node, wherein the plurality of reference signal symbols correspond to a first antenna port; and
transmit the reference signal symbols to the network node, and for each of one or more further antenna ports, transmitting further reference signal symbols to the network node.

69. The apparatus of claim 68, wherein selecting the plurality of reference signal symbols comprises selecting one of a plurality of different reference signal symbol sequences, wherein each reference signal symbol sequence is associated with a different value for the data.

70. An apparatus for receiving data from a network node, the apparatus comprising a processor and a memory, the memory containing instructions executable by the processor such that the apparatus is operable to:
receive a plurality of reference signal symbols from the network node, wherein the plurality of reference signal symbols correspond to a first antenna port, and for each of one or more further antenna ports, receiving further reference signal symbols from the network node; and
determine, based on the reference signal symbols, the data transmitted by the network node.

71. The apparatus of claim 70, wherein determining the data transmitted by the network node comprises determining that the plurality of reference signal symbols comprise one of a plurality of constellation points in a symbol constellation, wherein each constellation point represents a different reference signal symbol sequence.
